(19) United States
(12) Patent Application Publication
(10) Pub. No.: US 2015/0056478 A1
(43) Pub. Date: Feb. 26, 2015

(54) LITHIUM-ION SECONDARY BATTERY SYSTEM, INSPECTION METHOD FOR LITHIUM-ION SECONDARY BATTERY, AND CONTROL METHOD FOR LITHIUM-ION SECONDARY BATTERY

(71) Applicant: Hitachi, Ltd., Chiyoda-ku, Tokyo (JP)

(72) Inventor: Tsunenori Yamamoto, Tokyo (JP)

(73) Assignee: Hitachi, Ltd., Chiyoda-ku, Tokyo (JP)

(21) Appl. No.: 14/379,463

(22) PCT Filed: Jan. 23, 2013
(86) PCT No.: PCT/JP2013/051240

§ 371 Date: Aug. 18, 2014

(30) Foreign Application Priority Data
Mar. 8, 2012 (JP) 2012-051132

(51) Int. Cl. H01M 10/48; H01M 10/0525

(52) U.S. Cl. CPC H01M 10/48; H01M 10/0525; H01M 2220/20
USPC 429/50; 429/90

(57) ABSTRACT

Provided is a secondary battery system adapted to immediately detect that a lithium-ion secondary battery has entered a region in which the battery deteriorates in accordance with the t-law. The lithium-ion secondary battery system includes: a lithium-ion secondary battery; an acoustic emission (AE) sensor that detects an AE signal occurred in the lithium-ion secondary battery; an AE signal detector that detects the AE signal sent from the AE sensor; and a controller to which a signal from the AE signal detector is input. When a count of AE events which occur in a low-voltage region of one charge/discharge cycle of the lithium-ion secondary battery equals or exceeds a threshold value, the controller outputs a signal denoting a start of the deterioration of the lithium-ion secondary battery.

### TECHNICAL FIELD

The present invention relates to lithium-ion secondary battery systems, inspection methods for lithium-ion secondary batteries, and control methods for lithium-ion secondary batteries.

### BACKGROUND ART

In the fields of motor vehicles and railroad vehicles is known the hybrid scheme employing a secondary battery, such as a lead-acid, nickel metal hydride, or lithium-ion battery. The secondary battery stores the electrical energy that has been obtained during regenerative braking, and this electrical energy is used for acceleration and other purposes to provide better fuel economy. Electric automobiles actuated by the electrical energy stored within a secondary battery are also known. Meanwhile, in the fields of wind power generation and solar-light power generation applications, load leveling that uses a secondary battery system during connection to electric power transmission systems is being demanded at the conversion of fluctuating natural energy into electricity.

In these hybrid automobiles, electric automobiles, and other vehicles, or in secondary battery systems for the storage of electricity, a lithium-ion secondary battery is usually used in terms of enhancing energy density. Since the lithium-ion secondary battery contains a non-aqueous organic solvent as its electrolyte solution, it is very important, in a perspective of safety as well as effectiveness, to better understand a deterioration state and state-of-health (SOH) of the secondary battery used in a secondary battery system. It is also very important to predict the life and other characteristics of the secondary battery system in order to obtain information about what characteristics the system will exhibit.

The lithium-ion secondary battery is known to have two types of characteristics deterioration tendencies: one is a tendency proportional to a square root of either time or the number of charge/discharge cycles (this tendency is called “√t-law”); and the other is a tendency proportional to either time or the number of charge/discharge cycles (this tendency is called “t-law”).

For example, Non-patent Document 1 describes a case in which a capacity of a lithium-ion secondary battery initially deteriorates in accordance with the √t-law and then over time, this deterioration changes to the deterioration dictated by the t-law. Non-patent Document 2 describes a case in which the deterioration of a secondary battery that follows the √t-law is caused primarily by a formation of a film.

A method for detecting the deterioration state and SOH of the secondary battery is described, for example, in Patent Document 1. The described means is configured to record the characteristics information (such as internal resistance) as to the secondary battery system that has been acquired in advance, and this information is used for execute processing intended to further obtain information about SOH and the like.

A method for detecting an internal state of the secondary battery is described in Patent Document 2. The described technique is configured to use a charge/discharge characteristics curve of a positive electrode/negative electrode material, thereby fitting a charge/discharge characteristics curve of the battery. Thus, the internal state is detected.

Furthermore, Patent Document 3 discloses a technique for improving detection accuracy of deterioration of a secondary battery. This technique is intended to improve the detection accuracy of deterioration by providing means that measures a temperature of the secondary battery which will be subjected to charge/discharge tests, and by measuring the battery temperature as well as a charge/discharge current value and a voltage value obtained when the charge/discharge current is supplied.

Moreover, Patent Document 4 discloses a method for mounting a plurality of acoustic emission sensors on a battery to examine an internal state of the battery, and detecting a region in the battery where acoustic emission has occurred. Besides, Patent Documents 5 and 6 disclose usage cases of acoustic emission, as improving techniques for detecting an internal state of a secondary battery and for a charging method.

### PRIOR ART DOCUMENTS

### Patent Documents

Patent Document 1: JP-2010-256323-A

Patent Document 2: JP-2009-80093-A

Patent Document 3: JP-2010-54428-A

Patent Document 4: JP-2010-40318-A

Patent Document 5: JP-1995-6795-A

Patent Document 6: JP-1995-85892-A

### Non-patent Documents

Non-patent Document 1: Journal of Power Sources, Vol. 155 (2006), p. 415

Non-patent Document 2: Electrochemistry, 78 (2010), p. 482

### SUMMARY OF THE INVENTION

### Problem to be Solved by the Invention

The prediction of deterioration characteristics of a lithium-ion secondary battery, however, is usually described using, for example, the √t-law that as described in Non-patent Document 2, which is applied to the deterioration caused primarily by a formation of a film. Little is contemplated about the deterioration tendency that as described in Non-patent Document 1, changes over time from the deterioration dictated by the √t-law, to the deterioration dictated by the t-law. The reasons for that are that it is not fully clarified how and why the deterioration of the lithium-ion secondary battery occurs, and thus that it is not possible to predict the timing in which the deterioration tendency changes from the deterioration dictated by the √t-law, to the deterioration dictated by the t-law, and to predict an inclination in the deterioration dictated by the t-law.

The deterioration dictated by the t-law is generally abrupt, and the lithium-ion secondary battery that has entered a region in which the battery deteriorates in accordance with the t-law needs to be replaced as soon as practically possible. After the lithium-ion secondary battery has entered this deterioration region, therefore, the particular deterioration state needs detection at the earliest possible phase. It is also necessary to slow the deterioration of the lithium-ion secondary battery as much as possible in provision against failure to replace the battery at an early phase of the deterioration, and it is acceptable that the secondary battery has its usage range limited in that case.

Battery internal status detection in Patent Document 1 is a method effective only for the deterioration falling within a preassumed deterioration range, and this detection method usually envisages only deterioration patterns that fall within a range of the deterioration dictated by the √t-law. This method is therefore used to record only the characteristics information (such as internal resistance) acquired in the deterioration patterns dictated by the √t-law, and thus does not allow the detection of the timing in which the deterioration changes to that dictated by the t-law, and the internal state of the battery after it has entered the region of the deterioration dictated by the t-law.

The battery internal state examining method in Patent Document 2 enables detailed examination of the battery internal state. Separate data is however needed to determine, from examination results, whether the deterioration lies in the range of the √t-law or the range of the t-law. Use of the separate data will increase the amount of base data needed for the examination, call for fitting that suits a particular situation, and hence make it difficult to use the method in an actual secondary battery system.

Although the detection method described in Patent Document 3 is effective for examination in an actual usage state, this detection method also is means effective only for a battery deteriorating within a predicted deterioration range.

The method disclosed in Patent Document 4 is used only to detect the region in which acoustic emission has occurred, and is not intended to directly examine a deterioration level of the battery internal status. While the methods disclosed in Patent Documents 5 and 6 are also intended to detect the internal state of a secondary battery by use of an acoustic emission signal, these two documents only present the means that solves problems associated with the detection of the internal state primarily of a lead-acid storage battery under a charged state, or with the improvement of a charging method. That is to say, the two patent documents do not present a method of internal state detection in anticipation of a way to discriminate between the deterioration of a lithium-ion battery that follows the √t-law, and the deterioration of this battery that follows the t-law.

The present invention aims at solving these problems. That is to say, an object of the invention is to provide a secondary battery system incorporating an internal-state detection method adapted to inspect an internal status of a lithium-ion secondary battery and detect any differences between a deterioration state of the lithium-ion secondary battery that follows the √t-law, and a deterioration state of the battery that follows the t-law, and thereby to detect, at an early phase, that the battery has entered a region in which it deteriorates in accordance with the t-law.

Another object of the present invention is to provide a secondary battery system adapted to prevent deterioration of a lithium-ion secondary battery in characteristics as much as possible upon entry into the region that the battery deteriorates in accordance with the t-law.

### Means for Solving the Problems

Some of the aspects characterizing the present invention are as follows:

(1) A lithium-ion secondary battery system including: a lithium-ion secondary battery, an acoustic emission (AE) sensor that detects an AE signal occurred in the lithium-ion secondary battery, an AE signal detector that detects the AE signal sent from the AE sensor, and a controller to which a signal from the AE signal detector is input; wherein, when a count of AE events which occur in a low-voltage region of one charge/discharge cycle of the lithium-ion secondary battery equals or exceeds a threshold value, the controller outputs a signal denoting a start of deterioration of the lithium-ion secondary battery.

(2) A lithium-ion secondary battery system including: a lithium-ion secondary battery, an acoustic emission (AE) sensor that detects an AE signal occurred in the lithium-ion secondary battery, an AE signal detector that detects the AE signal sent from the AE sensor, and a controller to which a signal from the AE signal detector is input; wherein, when the controller determines that a count of AE events which occur during one charge/discharge cycle of discharge of the lithium-ion secondary battery has reached or exceeded a threshold value, the controller outputs a signal denoting a start of deterioration of the lithium-ion secondary battery.

(3) A lithium-ion secondary battery system including: a lithium-ion secondary battery, an acoustic emission (AE) sensor that detects an AE signal occurred in the lithium-ion secondary battery, an AE signal detector that detects the AE signal sent from the AE sensor, and a controller to which a signal from the AE signal detector is input; wherein, when a count of AE events which occur per discharge capacity of 1 Ah of the lithium-ion secondary battery equals or exceeds a threshold value, the controller outputs a signal denoting a start of deterioration of the lithium-ion secondary battery.

(4) A lithium-ion secondary battery system including: a lithium-ion secondary battery, an acoustic emission (AE) sensor that detects an AE signal occurred in the lithium-ion secondary battery, an AE signal detector that detects the AE signal sent from the AE sensor, and a controller to which a signal from the AE signal detector is input; wherein, when a count of AE events which occur per unit time in a low-voltage region of the lithium-ion secondary battery equals or exceeds a threshold value, the controller outputs a signal denoting a start of deterioration of the lithium-ion secondary battery.

(5) The lithium-ion secondary battery system in above item (4), further including a charger/discharger to control charging/discharging of the lithium-ion secondary battery, wherein: upon the lithium-ion secondary battery entering the low-voltage region, a time period is provided for the charger/discharger to discharge the lithium-ion secondary battery at a constant voltage; and when a count of AE events which occur per unit time in the constant-voltage discharging time period equals or exceeds a threshold value, the controller outputs a signal denoting a start of deterioration of the lithium-ion secondary battery.

(6) The lithium-ion secondary battery system in any one of above items (1) to (5), wherein the threshold value is at least one of the following: the count of AE events which occur during one charge/discharge cycle of the lithium-ion secondary battery is at least 10; the count of AE events which occur per unit time in the lithium-ion secondary battery is at least 10; and the count of AE events which occur per discharge capacity of 1 Ah of the lithium-ion secondary battery is at least 10.

(7) The lithium-ion secondary battery system in any one of items (1) to (5), wherein the threshold value is a value 10 times as large as the number of AE events occurring during an initial usage phase of the lithium-ion secondary battery.

(8) The lithium-ion secondary battery system in any one of items (1) and (4) to (7), wherein the low-voltage region is within +0.5 V of a lower discharge voltage limit in the lithium-ion secondary battery.

(9) The lithium-ion secondary battery system in any one of items (1) and (4) to (7), wherein the low-voltage region is within the lower half of a low-voltage side of an operating voltage range of the lithium-ion secondary battery.

(10) The lithium-ion secondary battery system in any one of above items (1) to (9), wherein the AE sensor detects AE events of at least 30 kHz.

(11) The lithium-ion secondary battery system in any one of above items (1) to (9), wherein the AE sensor detects AE events ranging from 30 kHz to 60 kHz inclusive.

(12) The lithium-ion secondary battery system in any one of above items (1) to (11), wherein the controller outputs a signal ensuring that a charge/discharge range of the lithium-ion secondary battery operative after the signal denoting the deterioration of the battery has been output will be narrowed relative to a charge/discharge range operative before the signal denoting the deterioration of the battery was output.

(13) The lithium-ion secondary battery system in above item (12), wherein: after the signal denoting the deterioration of the lithium-ion secondary battery has been output, when a voltage of the lithium-ion secondary battery decreases below a predefined value, the controller outputs a signal that inhibits use of the lithium-ion secondary battery.

(14) The lithium-ion secondary battery system in above item (13), wherein: after the controller has output the signal denoting the deterioration of the lithium-ion secondary battery, the AE signal detector measures the number of AE events which have occurred per unit time in the lithium-ion secondary battery; the controller records, as an AE detection voltage, a voltage of the lithium-ion secondary battery operative when the number of AE events which occurred per unit time is determined by the controller to be at least 10 per hour; and if the voltage of the lithium-ion secondary battery is equal to or less than the AE detection voltage, the controller outputs the signal that inhibits the use of the lithium-ion secondary battery.

(15) A method for inspecting a lithium-ion secondary battery in a lithium-ion secondary battery system, the lithium-ion secondary battery system including: a lithium-ion secondary battery; an acoustic emission (AE) sensor that detects an AE signal occurred in the lithium-ion secondary battery; an AE signal detector that detects the AE signal sent from the AE sensor; and a controller to which a signal from the AE signal detector is input; wherein, when a count of AE events which occur in a low-voltage region during one charge/discharge cycle of the lithium-ion secondary battery equals or exceeds a threshold value, the controller outputs a signal denoting a start of deterioration of the lithium-ion secondary battery.

(16) A lithium-ion secondary battery control method using the lithium-ion secondary battery inspection method of above item (15), wherein: the controller outputs a signal ensuring that a charge/discharge range of the lithium-ion secondary battery operative after the signal denoting the deterioration of the battery has been output will be narrowed relative to a charge/discharge range operative before the signal denoting the deterioration of the battery was output.

### Effects of the Invention

The present invention provides a secondary battery system incorporating an internal-state detection method, which detects any differences of the lithium-ion secondary battery between a deterioration state following the √t-law, and that following the t-law. The internal-state detection method thereby can detect, at an early phase, that the battery has entered a region in which it deteriorates in accordance with the t-law.

The present invention also provides a secondary battery system that minimizes characteristics deterioration of a lithium-ion secondary battery which has entered a deterioration region dictated by the t-law. Other issues, constituent elements, and advantageous effects will be apparent from the detailed description of embodiments that follow.

### BRIEF DESCRIPTION OF THE DRAWINGS

FIG. 1 is a block diagram of a secondary battery system according to a first embodiment.

FIG. 2 is a flowchart of internal state detection of the secondary battery system according to the first embodiment.

FIG. 3 shows an example of measurement results on occurrence rates of AE events and a battery capacity retention rate, in the secondary battery system according to the first embodiment.

FIG. 4 shows an example of measurement results on the occurrence of AE events and lithium-ion battery voltages, in the secondary battery system according to the first embodiment,.

FIG. 5 is a flowchart of internal state detection of a secondary battery system according to a second embodiment.

FIG. 6 is a flowchart of internal state detection of a secondary battery system according to a third embodiment.

FIG. 7 is a flowchart of internal state detection of a secondary battery system according to a fourth embodiment.

FIG. 8 is a block diagram of a secondary battery system according to a fifth embodiment.

FIG. 9 is a flowchart of internal state detection of the secondary battery system according to the fifth embodiment.

FIG. 10 is a flowchart of internal state detection of a secondary battery system according to a sixth embodiment.

FIG. 11 is a flowchart of internal state detection of a secondary battery system according to a seventh embodiment.

FIG. 12 is a flowchart of internal state detection of a secondary battery system according to an eighth embodiment.

### MODES FOR CARRYING OUT THE INVENTION

Hereunder, specific embodiments of the present invention will be shown, whereby the detail of the invention will be specifically described. The following embodiments are presented as specific examples of the detail of the invention, and the invention is not limited to the embodiments and may be changed and modified in various forms by persons skilled in the art, within the scope of the technical idea disclosed herein. In all drawings illustrating the embodiments, elements having the same function will each be assigned the same reference number, and repeated description of these elements will be omitted.

### First Embodiment

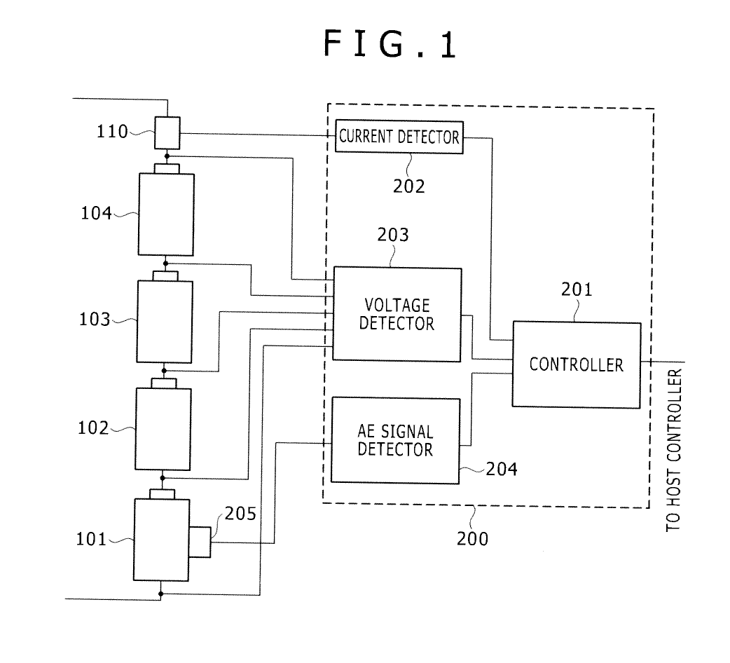

A block diagram of a secondary battery system according to a first embodiment is shown in FIG. 1. As shown in FIG. 1, the secondary battery system according to the first embodiment includes four lithium-ion secondary batteries, 101, 102, 103, and 104, that are connected in series to each other, a current sensor 110 that is also connected in series to one of the four lithium-ion secondary batteries, an acoustic emission (AE) sensor 205 in firm contact with the lithium-ion secondary battery 101, and a control unit 200. If the AE sensor 205 is difficult to bring into firm contact with the lithium-ion secondary battery 101, a metal (or the like) that allows ultrasonic waves to easily propagate therethrough may be placed between the AE sensor and a measurement object.

The control unit 200 includes a controller 201 to which a signal from an AE signal detector 204 is input, a current detector 202 that detects a signal sent from the current sensor 110 and measures input/output currents of the lithium-ion secondary batteries 101, 102, 103, and 104, a voltage detector 203 that detects voltages of the lithium-ion secondary batteries 101, 102, 103, and 104, and an AE signal detector 204 that detects a signal sent from the AE sensor 205.

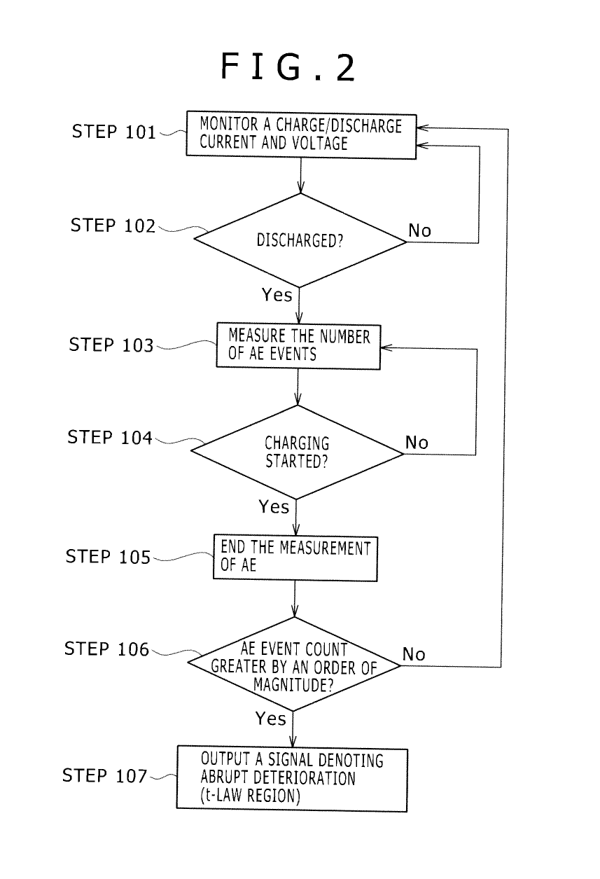

In the present embodiment, the controller 201 undertakes regular tasks relating to charge/discharge of the secondary battery system, such as control, state-of-charge (SOC) computation, and detection of battery states including SOH. In addition to these tasks, the controller 201 controls a sequence for detecting AE signals occurred in the lithium-ion secondary batteries and thus detecting an internal state of each battery. A flowchart of the internal-state detection sequence is shown in FIG. 2.

In step 101, the controller 201 monitors a charge/discharge current and voltage of each lithium-ion secondary battery, and then the sequence proceeds to step 102.

In step 102, whether the lithium-ion secondary battery is in a discharge state is determined from results of the charge/discharge current and voltage monitoring of the lithium-ion secondary battery in step 101. The sequence proceeds to step 103 if the lithium-ion secondary battery is in the discharge state. If this is not the case, the sequence returns to step 101.

In step 103, the AE signal detector 204 measures the number of AE events which have occurred during one charge/discharge cycle of discharge of the lithium-ion secondary battery, and then the sequence proceeds to step 104. The controller 201 may measure the number of AE events in step 103.

In step 104, it is determined whether charging of the lithium-ion secondary battery has been started. The sequence proceeds to step 105 if the charging of the lithium-ion secondary battery has been started. If this is not the case, the sequence returns to step 103.

In step 105, the AE signal detector 204 finishes detecting the number of AE events, and then the sequence proceeds to step 106.

In step 106, the controller 201 determines whether the number of AE events that was measured in step 103 is greater than or equal to a threshold value. The sequence proceeds to step 107 if the measured number of AE events is greater than or equal to the threshold value. If this is not the case, the sequence returns to step 101. In the present embodiment, the threshold value is a value that is at least one order of magnitude greater than a numeral that has been recorded in a flash memory or the like of the controller 201 in advance, that is, a value 10 times as large as the number of AE events occurring initially during the use of the secondary battery system.

In step 107, the controller 201 outputs to a host controller a signal indicating that the lithium-ion secondary battery has entered an abrupt deterioration region denoted by the t-law. The host controller is, for example, a main body section of a battery-including motor vehicle or apparatus actuated by electric power supplied from a lithium-ion secondary battery. For example, the battery-including motor vehicle or apparatus here is a hybrid automobile, an electric automobile, or any other motor vehicle, or a secondary battery system for storage of electricity.

Under a normal operating state of the secondary battery system, the charge/discharge current and voltage are continuously monitored by the controller 201. In the present embodiment, however, operation is controlled so that as described above, during charge/discharge current and voltage monitoring, the number of AE events is measured when the discharge state is confirmed. When charging starts, the measurement of the number of AE events is finished and if the measured number of AE events is a value that is at least one order of magnitude greater than the numeral previously recorded in the flash memory or the like of the controller 201, the controller 201 outputs to the host controller the signal indicating that the lithium-ion secondary battery has entered the abrupt deterioration region denoted by the t-law.

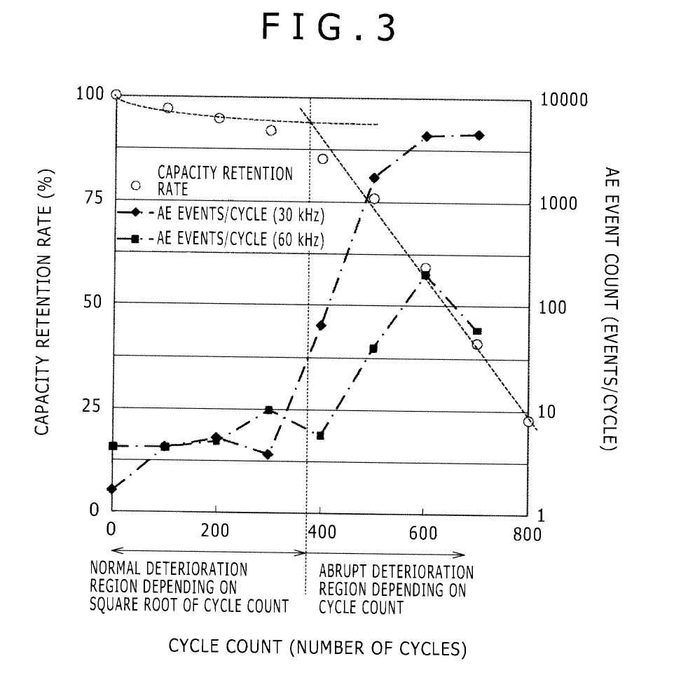

Shown in FIG. 3 are measurement results on the number of AE events and on a capacity retention rate of the lithium-ion secondary batteries, during actual charge/discharge cyclic testing of the secondary battery system according to the present embodiment.

FIG. 3 is a graph representing a charge/discharge cycle count on a horizontal axis, the capacity retention rate on a left vertical axis, and AE event detection counts per cycle represented in logarithmic terms on a right vertical axis. The capacity retention rate is plotted with a circle (◯), the number of AE events which were detected per cycle using a 30-kHz resonance frequency are shown with a black rhombic marking (♦), and the number of AE events which were detected per cycle using a 60-kHz resonance frequency are shown with a black rectangular marking (▪).

Although the AE sensor used in the present embodiment has a resonance frequency of 30 kHz and can measure AE events of at least 30 kHz in frequency, an AE sensor having the resonance frequency of 60 kHz and capable of measuring AE events of at least 60 kHz in frequency was also used to measure AE event data in the same battery configuration as in the embodiment. The former measurement results and the latter ones are shown together for comparison.

FIG. 3 indicates that the capacity retention rate decreases with increases in cycle count, and a region up to immediate front of approximately 400 cycles is estimated to be where the deterioration of the capacity retention rate makes gradual progress depending on a square root of the cycle count. At the same time, FIG. 3 also indicates that after 400 cycles, the deterioration makes abrupt progress depending on the cycle count.

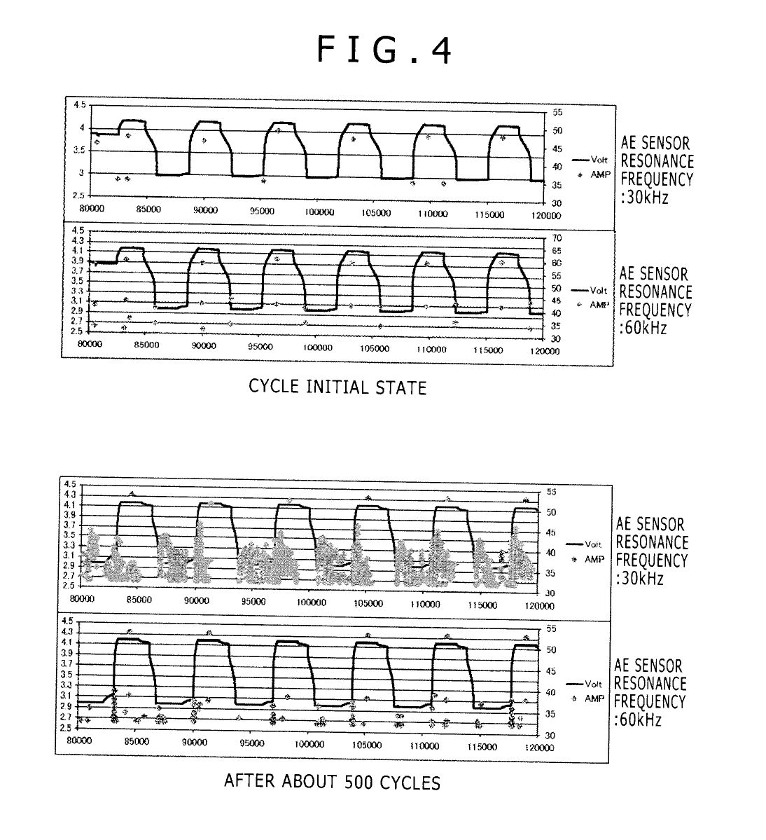

In the region with the deterioration of the capacity retention rate depending on the square root of the cycle count, the AE event count is not too high and is a value that is less than about 10 events/cycle, the same level as detected initially during the use of the secondary battery system. It can be seen, on the other hand, that in the region after 400 cycles, where the deterioration makes abrupt progress depending on the cycle count, the AE event count abruptly increases from an initial value. More specifically, initial cycle counts during the use of the battery system are expressed as from 1 to 10 cycles, as shown in FIGS. 3 and 4, but may take other values.

These increases in AE event count also depend on the resonance frequency of the AE sensor. In a case of the sensor having the resonance frequency of 30 kHz, a value of about 90 events/cycle is measured at 400 cycles and a value exceeding 1,000 events/cycle is measured at 500 cycles. In a case of the AE sensor having the resonance frequency of 60 kHz, on the other hand, a value as small as about 10 events/cycle, the same level as detected initially, is measured at 400 cycles and not too large a value of about 50 events/cycle at most is finally measured at 500 cycles.

As described above, in the present embodiment, when the capacity retention rate enters the region in which it abruptly deteriorates depending on the cycle count, the phenomenon that the number of AE events occurring in the lithium-ion secondary battery increases abruptly can be detected by the measurement with the AE sensor of 30 kHz in resonance frequency.

Next, the AE event count values in FIG. 3 that were obtained initially as well as at about 500 cycles during the charge/discharge cyclic tests are shown in FIG. 4 together with changes in the voltage of the lithium-ion secondary battery.

A horizontal axis in FIG. 4 denotes time in seconds. A left vertical axis denotes the voltage in volts (V) and a right vertical axis denotes detected AE event signal strength in decibels (dB). The AE events are plotted with ♦ at the corresponding strength positions in the corresponding time, and the changes in the voltage of the lithium-ion secondary battery are denoted by a solid line. The number of AE events was simultaneously measured with the two kinds of AE sensors of 30 kHz and 60 kHz in resonance frequency, and both two sets of measured values are shown in FIG. 4. The, results in FIG. 4 that were initially obtained during cyclic testing indicate that substantially no AE events were measured with either AE sensor.

The results indicate, on the other hand, that after about 500 cycles, a very large number of AE events occurred from a second half of the discharge up until after the discharge, and to a start of charging, during the AE event measurement with the 30-kHz AE sensor. The results also indicate that the 60-kHz AE sensor did not detect an AE event as often as the 30-kHz sensor did. This means that the AE events that occurred from the second half of the discharge up until after the discharge, and to the start of charging, were detected at frequencies primarily from 30 kHz to 60 kHz.

For this reason, the 30-kHz AE sensor having a high measuring sensitivity to AE events is used in the present embodiment, and a period from the middle of the discharge to the start of charging, that is, a period that is high in AE occurrence rate and great in difference with respect to the occurrence rate during the initial phase of the cyclic tests, is taken as an AE event measuring period in the embodiment.

Based on above, in the present embodiment, the acoustic emission (AE) that occurs in the lithium-ion battery during and after discharge is detected using the AE sensor of 30 kHz in resonance frequency. Besides, whether the detected AE event count is at least one order of magnitude greater than an initially set value is adopted as a criterion for detecting the differences between the deterioration states of the lithium-ion secondary battery that follow the √t-law and the t-law. The fact that the lithium-ion secondary battery has entered the region where it deteriorates according to the t-law can thus be detected immediately and in early timing.

### Second Embodiment

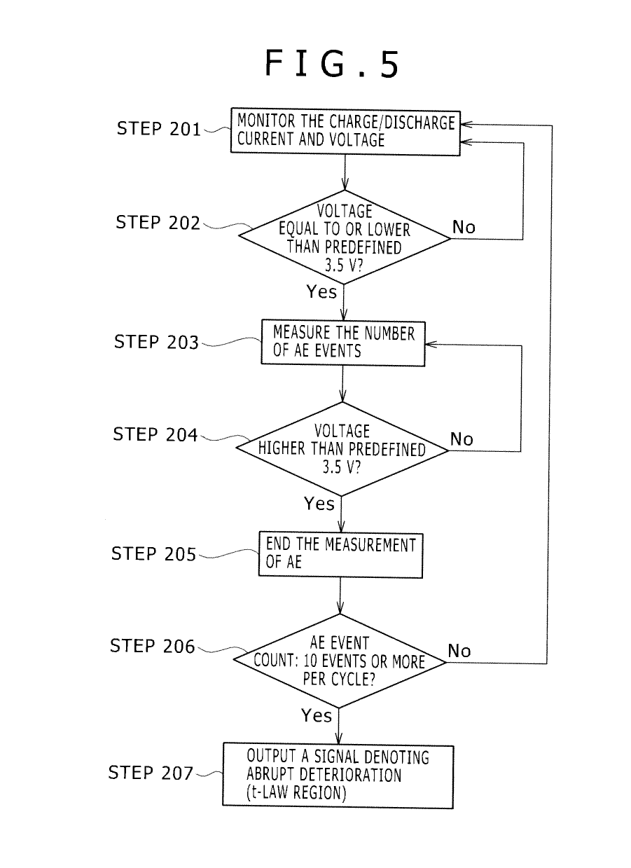

A second embodiment of the present invention is substantially the same as the first embodiment, except in the following context. FIG. 5 shows a sequence in which is detected an internal state of a secondary battery system according to the second embodiment.

In the present embodiment, a time period for measuring the number of AE events is defined in terms of a voltage range during charge/discharge cycles, and a low-voltage region, in particular, that is high in AE occurrence rate and great in difference with respect to the occurrence rate during an initial phase of the cycles is taken as the AE event measuring period. In addition, a threshold level for abrupt deterioration is defined as a value of at least 10 AE events per cycle, not a value that is 10 times as large as an initial value of the threshold. Any minimum value from 8 to 12 may be defined, depending on the kind of battery used. If too many AE events occur, these AE events are likely to have continuously occurred and many AE events may be erroneously measured as one AE event, so a value up to 1,000 events/cycle is desirably defined as the threshold level for abrupt deterioration.

In step 201, the controller 201 monitors a charge/discharge current and voltage of each lithium-ion secondary battery, and then the sequence proceeds to step 202.

In step 202, whether the battery voltage of the lithium-ion secondary battery is lower than or equal to a predefined value of 3.5 V is determined from results of the charge/discharge current and voltage monitoring of the lithium-ion secondary battery in step 201. The sequence proceeds to step 203 if the voltage of the lithium-ion secondary battery is lower than or equal to the predefined value of 3.5 V. If this is not the case, the sequence returns to step 201.

In step 203, the AE signal detector 204 measures the number of AE events which have occurred when the voltage of the lithium-ion secondary battery was lower than or equal to 3.5 V, and then the sequence proceeds to step 204.

In step 204, whether the voltage of the lithium-ion secondary battery is higher than the predefined value of 3.5 V is determined from results of the charge/discharge current and voltage monitoring of the lithium-ion secondary battery in step 201. The sequence proceeds to step 205 if the voltage of the lithium-ion secondary battery is higher than the predefined value of 3.5 V. If this is not the case, the sequence returns to step 203.

In step 205, the AE signal detector 204 finishes detecting the number of AE events, and then the sequence proceeds to step 206.

In step 206, it is determined whether the number of AE events per cycle that was measured in step 203 is at least 10. The sequence proceeds to step 207 if the measured number of AE events per cycle is at least 10. If this is not the case, the sequence returns to step 201.

In step 207, the controller 201 outputs to a host controller a signal indicating that the lithium-ion secondary battery has entered an abrupt deterioration region denoted by the t-law.

It can be seen that as shown in FIG. 4, the occurrence rate of AE events in the example of measurement after about 500 cycles is high in the region where the lithium-ion secondary battery develops a low voltage. In the present embodiment, more specifically, AE events are measured during the period up to 3.5 V to which the battery voltage rises by +0.5 V from a lower discharge voltage limit of 3.0 V. Although in the present embodiment the occurrence rate of AE events is measured in the range from 3.0 V to 3.5 V, an upper limit may be set to 3.3 V or 3.4 V, depending on the number of AE events detected.

Based on above, in the present embodiment, the acoustic emission (AE) that occurs in the lithium-ion battery is also detected in the low-voltage region during the charge/discharge process by use of the AE sensor of 30 kHz in resonance frequency. Besides, whether a minimum detection count of AE events per cycle is 10 events is adopted as a criterion for detecting the differences between the deterioration states of the lithium-ion secondary battery that follow the √t-law and the t-law. The fact that the lithium-ion secondary battery has entered the region where it deteriorates according to the t-law can thus be detected immediately and in early timing.

### Third Embodiment

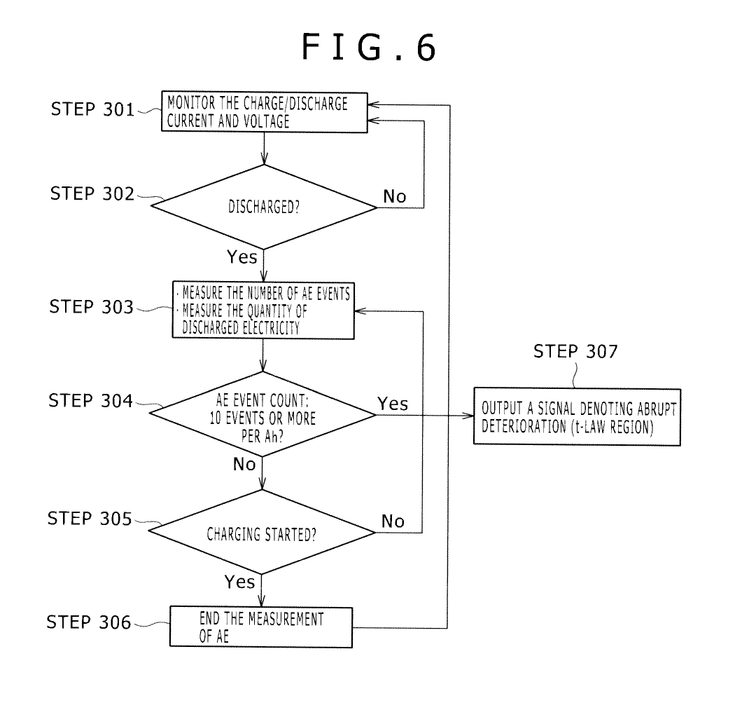

A third embodiment of the present invention is substantially the same as the first embodiment, except in the following context. FIG. 6 shows a sequence in which is detected an internal state of a secondary battery system according to the third embodiment.

While the present embodiment is the same as the first embodiment in that the number of AE events which have occurred is measured during a discharge period, the former differs from the latter in that the number of AE events which occurred is counted per unit discharge capacity, not in the number of cycles. Thus, even when the secondary battery system is applied to an EV in which the charge/discharge cycles vary, for example in such a way that the vehicle travels through a different distance each day, the differences between the deterioration states of the lithium-ion secondary battery that follow the √t-law and the t-law can be detected accurately. In addition, a threshold level that indicates an abrupt deterioration tendency is defined by the number of AE events that occurred. Specifically, the threshold level is defined as a value of at least 10 AE events per discharge capacity of 1 Ah, not a value that is 10 times as large as an initial value of the threshold level.

In step 301, the controller 201 monitors a charge/discharge current and voltage of each lithium-ion secondary battery, and then the sequence proceeds to step 302.

In step 302, whether the lithium-ion secondary battery is in a discharge state is determined from results of the charge/discharge current and voltage monitoring of the lithium-ion secondary battery in step 301. The sequence proceeds to step 303 if the lithium-ion secondary battery is in the discharge state. If this is not the case, the sequence returns to step 301.

In step 303, the AE signal detector 204 measures the number of AE events which have occurred for the unit discharge capacity of 1 Ah of the lithium-ion secondary battery, and then the sequence proceeds to step 304.

In step 304, it is determined whether the number of AE events that was measured for the unit discharge capacity of 1 Ah of the lithium-ion secondary battery in step 303 is at least 10. The sequence proceeds to step 307 if the measured number of AE events is at least 10. If this is not the case, the sequence returns to step 305.

In step 305, it is determined whether charging of the lithium-ion secondary battery has been started. The sequence proceeds to step 306 if the charging of the lithium-ion secondary battery has been started. If this is not the case, the sequence returns to step 303.

In step 306, the AE signal detector 204 finishes measuring the number of AE events, and then the sequence proceeds to step 301.

In step 307, the controller 201 outputs to a host controller a signal indicating that the lithium-ion secondary battery has entered an abrupt deterioration region denoted by the t-law.

The lithium-ion secondary battery shown in FIGS. 3 and 4 has a capacity of about 1.3 Ah and the discharge capacity of 1 Ah is equivalent to nearly one cycle, so it can also be seen from FIGS. 3 and 4 that the value of 10 events/Ah (the amount of electricity discharged) is an appropriate value.

Based on above, in the present embodiment, the acoustic emission (AE) that occurs in the lithium-ion battery is also detected in the low-voltage region during the charge/discharge process by use of the AE sensor of 30 kHz in resonance frequency. Besides, whether an actual AE event detection count is greater than or equal to a threshold value of 10 events/Ah (unit discharge capacity) is adopted as a criterion for detecting the differences between the deterioration states of the lithium-ion secondary battery that follow the √t-law and the t-law. The fact that the lithium-ion secondary battery has entered the region where it deteriorates according to the t-law can thus be detected immediately and in early timing.

### Fourth Embodiment

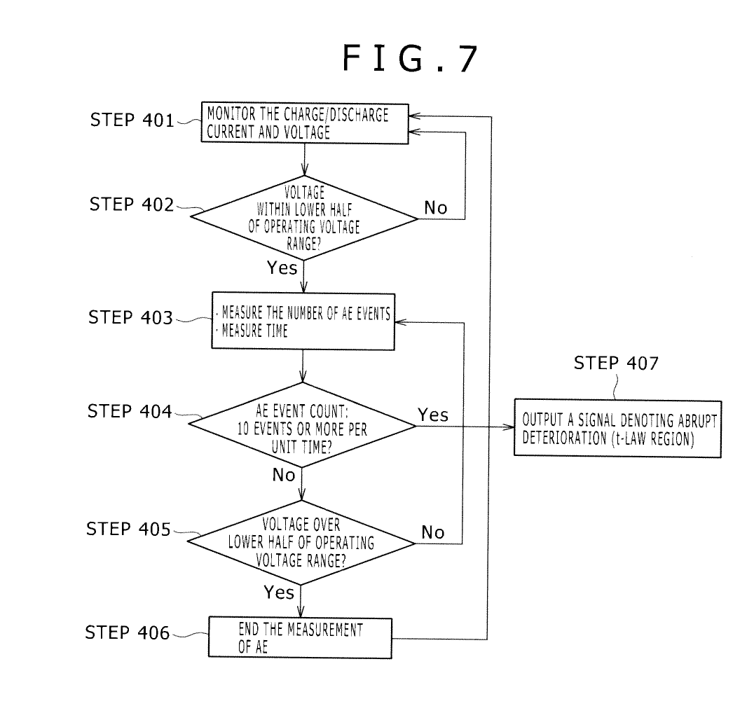

A fourth embodiment of the present invention is substantially the same as the second embodiment, except in the following context. FIG. 7 shows a sequence in which is detected an internal state of a secondary battery system according to the fourth embodiment.

While the present embodiment is the same as the second embodiment in that the measuring period of the AE event occurrence rate is defined in terms of the voltage range during charge/discharge, the former differs from the latter in that the low-voltage range is set as a low-voltage side that is the lower half of an operating voltage range of the battery. Since the battery in the present embodiment is from 4.2 V to 3.0 V in operating voltage range, the occurrence rate of AE events is measured when the battery is exhibiting any voltage within a range of 3.6 V−3.0 V, the lower half of the operating voltage range.

The present embodiment also differs from the second embodiment in that the number of AE events which occurred is counted per unit time, not in the number of cycles. Thus, even when the secondary battery system is applied to an EV in which the charge/discharge cycles vary, for example in such a way that the vehicle travels through a different distance each day, the differences between the deterioration states of the lithium-ion secondary battery that follow the √t-law and the t-law can be detected accurately. In addition, a threshold level that indicates an abrupt deterioration tendency is defined by the number of AE events that occurred. Specifically, the threshold level is defined as a value of at least 10 AE events per unit time, not a value that is 10 times as large as an initial value of the threshold level.

In step 401, the controller 201 monitors a charge/discharge current and voltage of each lithium-ion secondary battery, and then the sequence proceeds to step 402.

In step 402, whether the voltage of the lithium-ion secondary battery is within the lower half of the operating voltage range of the battery is determined from results of the charge/discharge current and voltage monitoring of the lithium-ion secondary battery in step 401. The sequence proceeds to step 403 if the voltage of the lithium-ion secondary battery is within the lower half of the operating voltage range. If this is not the case, the sequence returns to step 401.

In step 403, the AE signal detector 204 measures the number of AE events which have occurred for unit time in the low-voltage region of the lithium-ion secondary battery, and then the sequence proceeds to step 404.

In step 404, it is determined whether the number of AE events that was measured in step 403 is at least 10. The sequence proceeds to step 407 if the measured number of AE events is at least 10. If this is not the case, the sequence returns to step 405.

In step 405, whether the voltage of the lithium-ion secondary battery is over the lower half of the operating voltage range of the battery is determined from results of the charge/discharge current and voltage monitoring of the lithium-ion secondary battery in step 401. The sequence proceeds to step 406 if the voltage of the lithium-ion secondary battery is over the lower half of the operating voltage range. If this is not the case, the sequence returns to step 403.

In step 406, the AE signal detector 204 finishes measuring the number of AE events, and then the sequence returns to step 401.

In step 407, the controller 201 outputs to a host controller a signal indicating that the lithium-ion secondary battery has entered an abrupt deterioration region denoted by the t-law.

The lithium-ion secondary battery shown in FIG. 4 needs about two hours to complete one charge/discharge cycle, and practically no AE events occur under a fully charged state of 4.2 V. It can be seen from FIG. 4, therefore, that the value of 10 events/hour is a substantially appropriate value.

Based on above, in the present embodiment, the acoustic emission (AE) that occurs in the lithium-ion battery is also detected in the low-voltage region during the charge/discharge process by use of the AE sensor of 30 kHz in resonance frequency. Besides, whether an actual AE event detection count is greater than or equal to the threshold value of 10 events/hour is adopted as a criterion for detecting the differences between the deterioration states of the lithium-ion secondary battery that follow the √t-law and the t-law. The fact that the lithium-ion secondary battery has entered the region where it deteriorates according to the t-law can thus be detected immediately and in early timing.

### Fifth Embodiment

A fifth embodiment of the present invention is substantially the same as the fourth embodiment, except in the following context.

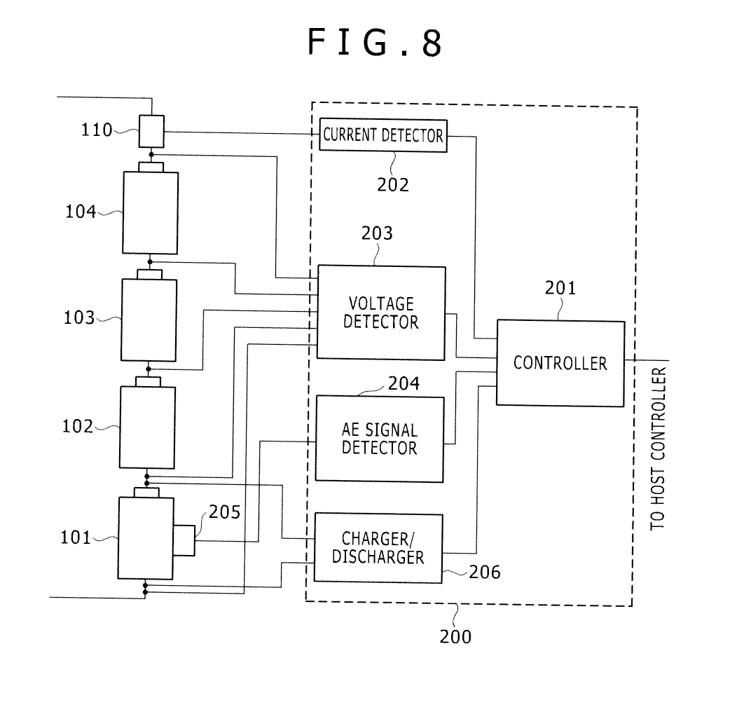

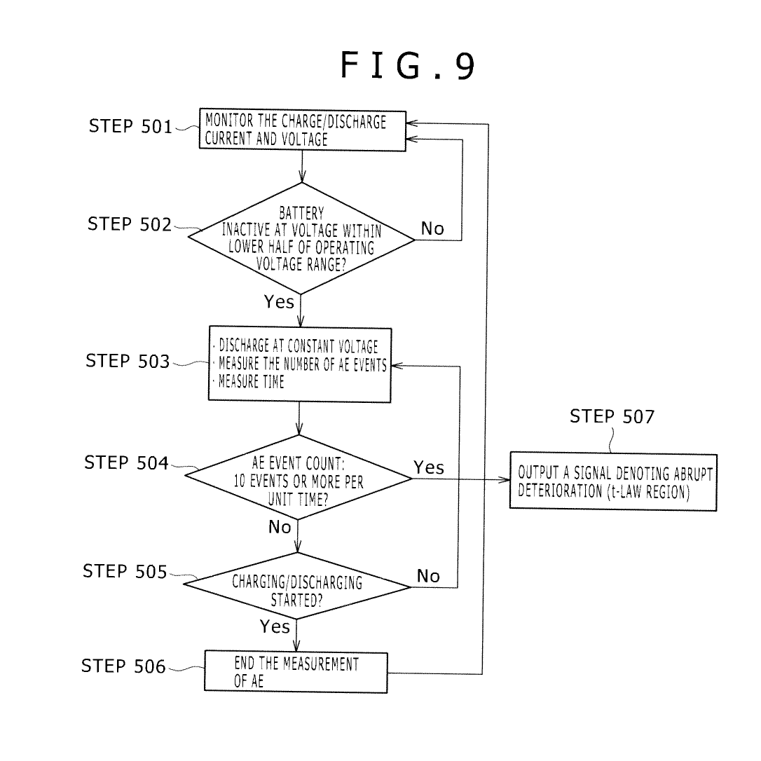

FIG. 8 shows a sequence in which is detected an internal state of a secondary battery system according to the fifth embodiment. The secondary battery system according to the present embodiment is characterized in that the controller 200 includes a charger/discharger 206 to control the charging/discharging of each lithium-ion secondary battery. FIG. 9 shows a sequence in which is detected an internal state of the secondary battery system according to the present embodiment.

The present embodiment is the same as the fourth embodiment in that the occurrence rate of AE events per unit time is measured in the low-voltage region (in this embodiment, the low-voltage region is a region within the lower half of an operating voltage range of the battery, as in fourth embodiment). In the predefined low-voltage region of the lithium-ion secondary battery, however, when the battery is in an inactive or pause state (there is no charge/discharge current flow), a period during which the battery is discharged at a constant voltage using the charger/discharger 206 is provided, in the period of which the occurrence rate of AE events per unit time is measured.

In step 501, the controller 201 monitors a charge/discharge current and voltage of each lithium-ion secondary battery, and then the sequence proceeds to step 502.

In step 502, whether the lithium-ion secondary battery currently has a voltage within the lower half of the operating voltage range of the battery and is in the inactive/pause state is determined from results of the charge/discharge current and voltage monitoring of the lithium-ion secondary battery in step 501. The sequence proceeds to step 503 if the lithium-ion secondary battery currently has a voltage within the lower half of the operating voltage range and is in the inactive/pause state. If this is not the case, the sequence returns to step 501.

In step 503, the AE signal detector 204 measures the number of AE events per hour in the period that the battery system uses the charger/discharger 206 to discharge the battery at a constant voltage, and then the sequence proceeds to step 504.

In step 504, it is determined whether the number of AE events that was measured in step 503 is at least 10. The sequence proceeds to step 507 if the measured number of AE events is at least 10. If this is not the case, the sequence proceeds to step 505.

In step 505, it is determined whether the charging of the lithium-ion secondary battery has been started. The sequence proceeds to step 506 if the charging of the lithium-ion secondary battery has been started. If this is not the case, the sequence returns to step 503.

In step 506, the AE signal detector 204 finishes measuring the number of AE events, and then the sequence returns to step 501.

In step 507, the controller 201 outputs to a host controller a signal indicating that the lithium-ion secondary battery has entered an abrupt deterioration region denoted by the t-law.

In the example of FIG. 4 relating to the AE event detection after about 500 cycles, a large number of AE events are detected during the 3.0-V constant-voltage discharge period. Additionally, there is a significant difference from an initial state in terms of AE event detection count.

Accordingly, in the present embodiment, the charger/discharger 206 is included in the control unit 200 and when the lithium-ion secondary battery becomes inactive or pauses under a low-voltage state, another constant-voltage discharge period is provided and the occurrence rate of AE events is measured during this period.

Based on above, in the present embodiment, when the lithium-ion secondary battery becomes inactive or pauses at a low voltage during the charge/discharge process, the occurrence rate of AE events per hour is also detected during another constant-voltage discharge period. Besides, whether an actual AE event detection count is greater than or equal to the threshold value of 10 events/hour is adopted as a criterion for detecting the differences between the deterioration states of the lithium-ion secondary battery that follow the √t-law and the t-law. The fact that the lithium-ion secondary battery has entered the region where it deteriorates according to the t-law can thus be detected immediately and in early timing.

### Sixth Embodiment

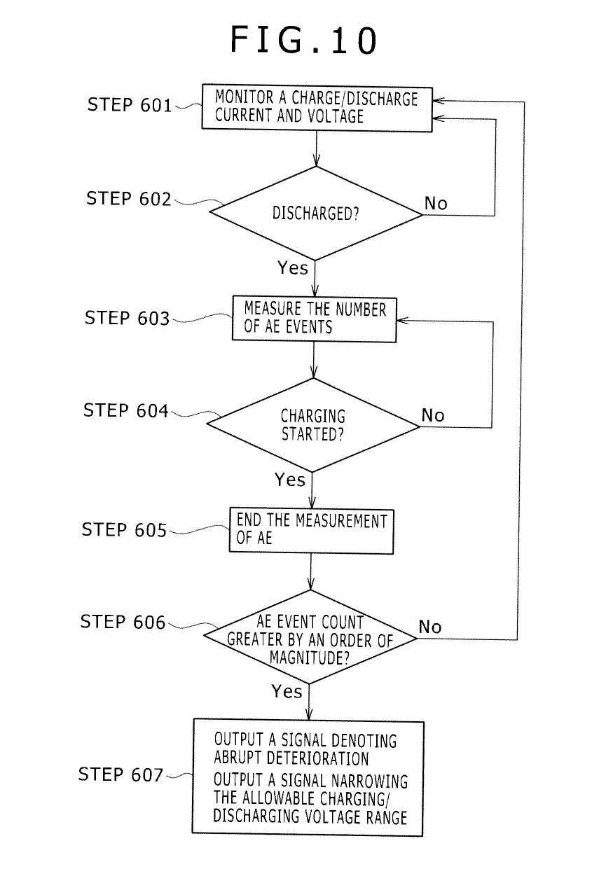

A sixth embodiment of the present invention is substantially the same as the first embodiment, except in the following context. FIG. 10 shows a sequence in which is detected an internal state of a secondary battery system according to the sixth embodiment.

The internal-state detection sequence in the present embodiment is substantially the same as that of the first embodiment. Upon detecting an increase in the number of AE events, the controller 201 outputs the signal indicating that the abrupt deterioration dictated by the t-law has begun. Additionally, the secondary battery system operates so that the charge/discharge range of each lithium-ion secondary battery operative after the signal denoting the deterioration of the battery has been output will be narrowed relative to the charge/discharge range operative before the signal denoting the deterioration of the battery was output. In other words, the secondary battery system outputs to a host controller a signal that reduces the amount of chargeable/dischargeable electricity (reduces a spread of depth-of-discharge).

Steps 601 to 606 are substantially the same as steps 101 to 106 of the first embodiment.

In step 607, the controller 201 outputs to the host controller the signal indicating that the lithium-ion secondary battery has entered the abrupt deterioration region denoted by the t-law, and the signal that narrows the charge/discharge range for the secondary battery system.

As shown in FIG. 4, the increase in the number of AE events occurs primarily in the low-voltage region, so the secondary battery system would become able to extend a useable time of the lithium-ion secondary battery by merely limiting the charge/discharge range so as not to use the low-voltage region.

Based on above, in the present embodiment, the acoustic emission (AE) that occurs in the lithium-ion battery during and after discharge, is detected and whether the detected AE event count is at least one order of magnitude greater than an initially set value is adopted as a criterion for detecting the differences between the deterioration states of the lithium-ion secondary battery that follow the √t-law and the t-law. The fact that the lithium-ion secondary battery has entered the region where it deteriorates according to the t-law can thus be detected immediately and in early timing. In addition to these advantages, in the present embodiment, the characteristics deterioration of the lithium-ion secondary battery which has entered the region where the battery deteriorates according to the t-law can be suppressed because the detection signal is output and because the signal that narrows the charge/discharge range is also output.

### Seventh Embodiment

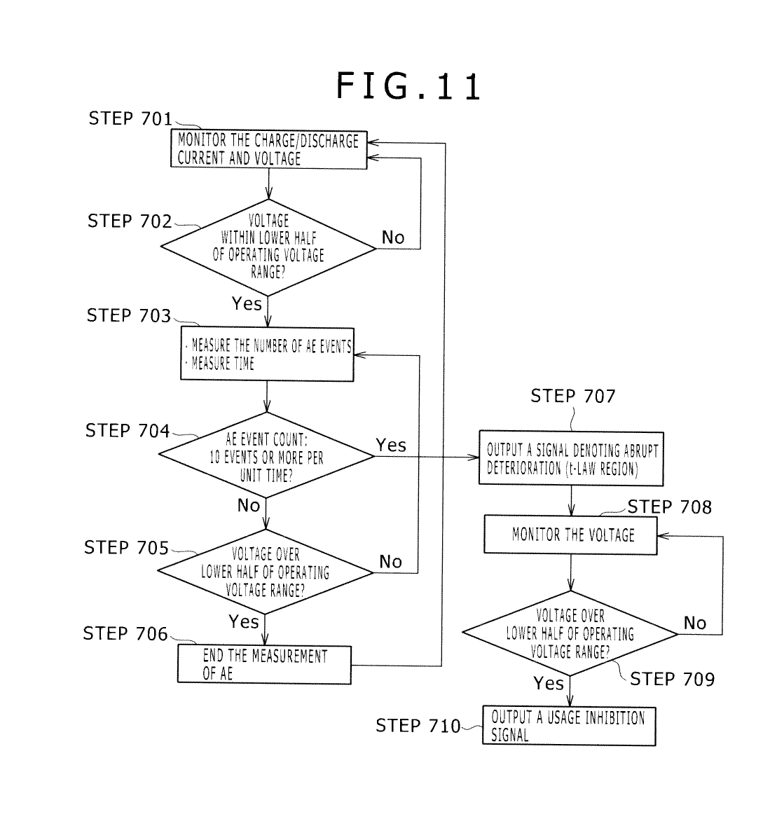

A seventh embodiment of the present invention is substantially the same as the fourth embodiment, except in the following context. FIG. 11 shows a sequence in which is detected an internal state of a secondary battery system according to the seventh embodiment.

The internal-state detection sequence in the present embodiment is substantially the same as that of the fourth embodiment. Upon detecting an increase in the number of AE events, the controller 201 outputs the signal indicating that the abrupt deterioration dictated by the t-law has begun in each lithium-ion secondary battery. After that, the controller 201 monitors the voltage of the battery and if the battery voltage decreases below a predefined value, outputs to a host controller a signal that inhibits the use of the battery.

Steps 701 to 706 are substantially the same as steps 401 to 406 of the fourth embodiment.

In step 707, the controller 201 outputs to the host controller the signal indicating that the lithium-ion secondary battery has entered the abrupt deterioration region denoted by the t-law, and then proceeds to step 708.

In step 708, the controller 201 monitors the voltage of the lithium-ion secondary battery. The sequence next proceeds to step 709.

In step 709, whether the voltage of the lithium-ion secondary battery is below the predefined value (the lower half of the operating voltage range of the battery) is determined from results of the charge/discharge current and voltage monitoring of the lithium-ion secondary battery in step 501. The sequence proceeds to step 710 if the voltage of the lithium-ion secondary battery is equal to or less than the predefined value. If this is not the case, the sequence returns to step 708.

In step 710, the controller 201 outputs to the host controller the signal that inhibits the use of the lithium-ion secondary battery.

As shown in FIG. 4, the increase in the number of AE events occurs primarily in the low-voltage region, so the secondary battery system would become able to extend a useable time of the lithium-ion secondary battery by merely limiting the charge/discharge range so as not to use the low-voltage region. In the present embodiment, the low-voltage region in which the battery usage inhibition signal is output is within the lower half of the operating voltage range, which is the same as the voltage range in which the AE events are detected.

Based on above, in the present embodiment, the acoustic emission (AE) that occurs in the lithium-ion battery during and after discharge is detected and whether the detected AE event count is at least 10 events/hour is adopted as a criterion for detecting the differences between the deterioration states of the lithium-ion secondary battery that follow the √t-law and the t-law. The fact that the lithium-ion secondary battery has entered the region where it deteriorates according to the t-law can thus be detected immediately and in early timing. In addition to these advantages, in the present embodiment, the characteristics deterioration of the lithium-ion secondary battery which has entered the region where the battery deteriorates according to the t-law can be suppressed because the detection signal is output and because the signal for inhibiting the use of the low-voltage region estimated to be the region where the deterioration dictated by the t-law progresses is also output.

### Eighth Embodiment

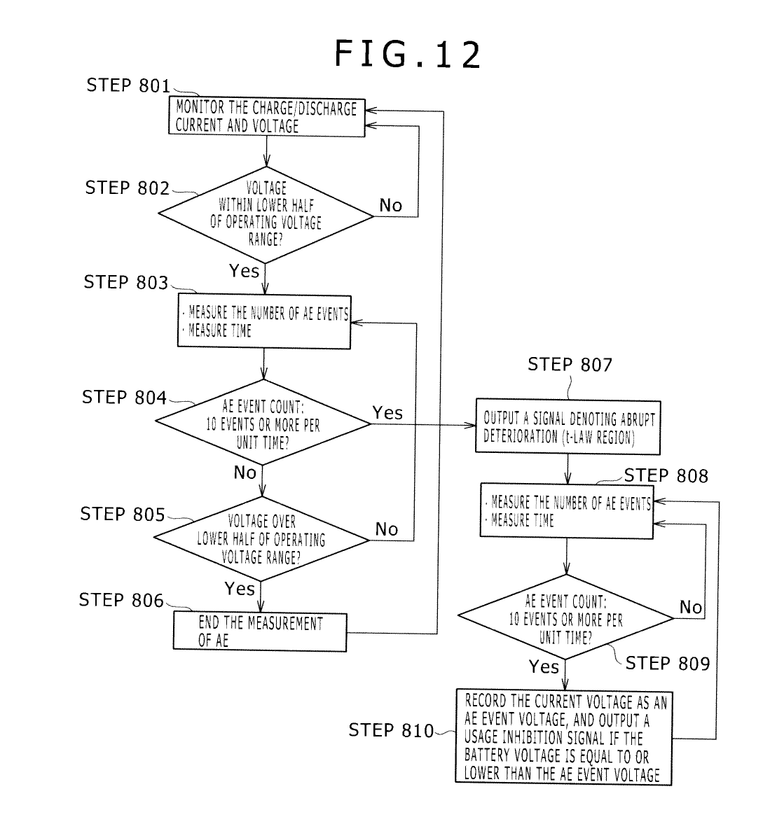

An eighth embodiment of the present invention is substantially the same as the seventh embodiment, except in the following context. FIG. 12 shows a sequence in which is detected an internal state of a secondary battery system according to the eighth embodiment.

The internal-state detection sequence in the present embodiment is substantially the same as that of the seventh embodiment. Upon detecting an increase in the number of AE events, the controller 201 outputs the signal indicating that the abrupt deterioration dictated by the t-law has begun in each lithium-ion secondary battery. After that, while the number of AE events in the lithium-ion secondary battery is being continuously measured, the controller 201 records the battery voltage (AE detection voltage) developed when the measured number of AE events per unit time is at least 10 per hour. If the lithium-ion secondary battery voltage decreases below the AE detection voltage, the controller 201 outputs the battery usage inhibition signal.

Steps 801 to 807 are substantially the same as steps 701 to 707 of the seventh embodiment.

In step 808, the AE signal detector 204 measures the number of AE events which have occurred in unit time, and then the sequence proceeds to step 809.

In step 809, it is determined whether the number of AE events that was measured in unit time in step 808 is at least 10. The sequence proceeds to step 810 if the measured number of AE events per unit time is at least 10. If this is not the case, the sequence proceeds to step 808.

In step 810, the controller 201 records the lithium-ion secondary battery voltage developed when the measured number of AE events per unit time is at least 10, as the AE detection voltage, and if the lithium-ion secondary battery currently has a voltage equal to or less than the AE detection voltage, the controller 201 outputs to a host controller the signal that inhibits the use of the lithium-ion secondary battery.

As shown in FIG. 4, the increase in the number of AE events occurs primarily in the low-voltage region. In addition, the occurrence of these AE events is estimated to be one of main causes of the deterioration dictated by the t-law. The secondary battery system would therefore become able to extend a useable time of the lithium-ion secondary battery by merely limiting the charge/discharge range so as not to use the region in which the AE events occur.

Based on above, in the present embodiment, the acoustic emission (AE) that occurs in the lithium-ion battery during and after discharge is detected and whether the detected AE event count is at least 10 events/hour is adopted as a criterion for detecting the differences between the deterioration states of the lithium-ion secondary battery that follow the √t-law and the t-law. The fact that the lithium-ion secondary battery has entered the region where it deteriorates according to the t-law can thus be detected immediately and in early timing.

In addition to these advantages, in the present embodiment, the characteristics deterioration of the lithium-ion secondary battery which has entered the region where the battery deteriorates according to the t-law can be suppressed because the detection signal is output and because a signal by which the use of the voltage region where a large number of AE events occur is inhibited during continuous measurement of the number of AE events is also output.

### DESCRIPTION OF REFERENCE NUMBERS

101, 102, 103, 104: Lithium-ion secondary batteries
110: Current sensor
200: Control unit
201: Controller
202: Current detector
203: Voltage detector
204: AE signal detector
205: AE sensor
206: Charger/discharger

1. A lithium-ion secondary battery system, comprising:
a lithium-ion secondary battery;
an acoustic emission (AE) sensor that detects an AE signal occurred in the lithium-ion secondary battery;
an AE signal detector that detects the AE signal sent from the AE sensor; and
a controller to which a signal from the AE signal detector is input, wherein
when a count of AE events which occur in a low-voltage region of one charge/discharge cycle of the lithium-ion secondary battery equals or exceeds a threshold value, the controller outputs a signal denoting a start of deterioration of the lithium-ion secondary battery.

2. A lithium-ion secondary battery system, comprising:
a lithium-ion secondary battery;
an acoustic emission (AE) sensor that detects an AE signal occurred in the lithium-ion secondary battery;
an AE signal detector that detects the AE signal sent from the AE sensor; and
a controller to which a signal from the AE signal detector is input, wherein
when the controller determines that a count of AE events which occur during one charge/discharge cycle of discharge of the lithium-ion secondary battery has reached or exceeded a threshold value, the controller outputs a signal denoting a start of deterioration of the lithium-ion secondary battery.

3. A lithium-ion secondary battery system, comprising:
a lithium-ion secondary battery;
an acoustic emission (AE) sensor that detects an AE signal occurred in the lithium-ion secondary battery;
an AE signal detector that detects the AE signal sent from the AE sensor; and
a controller to which a signal from the AE signal detector is input, wherein
when a count of AE events which occur per discharge capacity of 1 Ah of the lithium-ion secondary battery equals or exceeds a threshold value, the controller outputs a signal denoting a start of deterioration of the lithium-ion secondary battery.

4. A lithium-ion secondary battery system, comprising:
a lithium-ion secondary battery;
an acoustic emission (AE) sensor that detects an AE signal occurred in the lithium-ion secondary battery;
an AE signal detector that detects the AE signal sent from the AE sensor; and
a controller to which a signal from the AE signal detector is input, wherein,
when a count of AE events which occur per unit time in a low-voltage region of the lithium-ion secondary battery equals or exceeds a threshold value, the controller outputs a signal denoting a start of deterioration of the lithium-ion secondary battery.

5. The lithium-ion secondary battery system according to claim 4, further comprising a charger/discharger to control charging/discharging of the lithium-ion secondary battery, wherein
upon the lithium-ion secondary battery entering the low-voltage region, a time period is provided for the charger/discharger to discharge the lithium-ion secondary battery at a constant voltage, and
when a count of AE events which occur per unit time in the constant-voltage discharging time period equals or exceeds a threshold value, the controller outputs a signal denoting a start of deterioration of the lithium-ion secondary battery.

6. The lithium-ion secondary battery system according to claim 1, wherein
the threshold value is at least one of:
the count of AE events which occur during one charge/discharge cycle of the lithium-ion secondary battery is at least 10;
the count of AE events which occur per unit time in the lithium-ion secondary battery is at least 10; and
the count of AE events which occur per discharge capacity of 1 Ah of the lithium-ion secondary battery is at least 10.

7. The lithium-ion secondary battery system according to claim 1, wherein
the threshold value is a value 10 times as large as the number of AE events occurring during an initial usage phase of the lithium-ion secondary battery.

8. The lithium-ion secondary battery system according to claim 1, wherein
the low-voltage region is within +0.5 V of a lower discharge voltage limit in the lithium-ion secondary battery.

9. The lithium-ion secondary battery system according to claim 1, wherein
the low-voltage region is within the lower half of a low-voltage side of an operating voltage range of the lithium-ion secondary battery.

10. The lithium-ion secondary battery system according to claim 9, wherein
the AE sensor detects AE events of at least 30 kHz.

11. The lithium-ion secondary battery system according to claim 9, wherein
the AE sensor detects AE events ranging from 30 kHz to 60 kHz inclusive.

12. The lithium-ion secondary battery system according to claim 11, wherein
the controller outputs a signal ensuring that a charge/discharge range of the lithium-ion secondary battery operative after the signal denoting the deterioration of the battery has been output will be narrowed relative to a charge/discharge range operative before the signal denoting the deterioration of the battery was output.

13. The lithium-ion secondary battery system according to claim 12, wherein
after the signal denoting the deterioration of the lithium-ion secondary battery has been output, when a voltage of the lithium-ion secondary battery decreases below a predefined value, the controller outputs a signal that inhibits use of the lithium-ion secondary battery.

14. The lithium-ion secondary battery system according to claim 13, wherein
after the controller has output the signal denoting the deterioration of the lithium-ion secondary battery, the AE signal detector measures the number of AE events which have occurred per unit time in the lithium-ion secondary battery,
the controller records, as an AE detection voltage, a voltage of the lithium-ion secondary battery operative when the number of AE events which occurred per unit time is determined by the controller to be at least 10 per hour, and
if the voltage of the lithium-ion secondary battery is equal to or less than the AE detection voltage, the controller outputs the signal that inhibits the use of the lithium-ion secondary battery.

15. A method for inspecting a lithium-ion secondary battery in a lithium-ion secondary battery system, the lithium-ion secondary battery system including:
a lithium-ion secondary battery;
an acoustic emission (AE) sensor that detects an AE signal occurred in the lithium-ion secondary battery;
an AE signal detector that detects the AE signal sent from the AE sensor; and
a controller to which a signal from the AE signal detector is input, wherein
when a count of AE events which occur in a low-voltage region during one charge/discharge cycle of the lithium-ion secondary battery equals or exceeds a threshold value, the controller outputs a signal denoting a start of deterioration of the lithium-ion secondary battery.

16. A lithium-ion secondary battery control method using the lithium-ion secondary battery inspection method of claim 15, wherein
the controller outputs a signal ensuring that a charge/discharge range of the lithium-ion secondary battery operative after the signal denoting the deterioration of the battery has been output will be narrowed relative to a charge/discharge range operative before the signal denoting the deterioration of the battery was output.
